(19) United States
(12) Patent Application Publication
(10) Pub. No.: US 2004/0062840 A1
(43) Pub. Date: Apr. 1, 2004

(54) Pressure relief valve for food product packages

(76) Inventor: Mark D. Jamison, Zion, IL (US)

Correspondence Address: DOWELL & DOWELL PC, SUITE 309, 1215 JEFFERSON DAVIS HIGHWAY, ARLINGTON, VA, 22202

(21) Appl. No.: 10/671,722

(22) Filed: Sep. 29, 2003

Related U.S. Application Data
(60) Provisional application No. 60/414,400, filed on Sep. 30, 2002.

(51) Int. Cl. A23B 4/00

(52) U.S. Cl. 426/118

(57) ABSTRACT

The present invention provides a pressure relief valve for a flexible pouch which is integrated directly into the flexible pouch material. The valve permits excess of gas to dissipate through the valve mechanism but does not permit the reentry of air (hence oxygen) which maintains the food product fresh. The valve is integrated into the pouch material without implanting a fitment. The nature of the valve design results in the closing of the channels of the valve when gas is not discharging through the valve. A secondary purpose of the valve is to maintain the pressure in the pouch below an amount that can bloat the pouch to the extent that the seals can rupture and permit oxygen penetration or spilling of the contents outside the pouch. A nitrogen cap is maintained in the pouch thereby ensuring freshness of the product stored in the pouch.

### CROSS REFERENCE TO RELATED APPLICATIONS

This application relates to, and claims the benefit of, U.S. Provisional patent application Serial No. 60/414,400 filed Sep. 30, 2002, which is incorporated herein in its entirety.

### FIELD OF THE INVENTION

The present invention relates to pre-formed pressure release gas valves for use in flexible pouches.

### BACKGROUND OF THE INVENTION

To maintain freshness of foodstuffs in packaging, for example in the case of coffee, nitrogen is placed in the pouch to displace the oxygen trapped during forming, filling and sealing of fresh roasted ground or whole bean coffee. This nitrogen is referred to as a “nitrogen cap”. It is important to minimize the exposure of the packaged coffee to oxygen in order to maintain the flavor. Also, roasted coffee generates carbon dioxide as a by-product gas immediately after roasting and for several weeks thereafter. Specifically, fresh ground coffee produces large amounts of carbon dioxide gas as a by-product of the roasting process (Maillard browning reaction) which can act to swell the package making it unsightly and leading to a risk of over-pressurization thus causing a rupture in the packaging. With the reduction of gas in the pouch, the pressures exerted by the pouch diminishes.

The food industry has established standards in respect of gas permeation across the barrier in pouches. Thus it is necessary to be able to dissipate an excess of gas out of the pouch through some sort of valve mechanism that does not permit the reentry of oxygen. Currently, fitments of a valve type are attached externally to the pouch. These currently used valve types in the market place, which are external fitments that must be physically attached by a secondary method, are problematic in that the valves sometimes do not open when required and sometimes completely fail to open. These external devices add significant cost to the production cost of these types of pouch. In some cases foreign substances such as lubricants can migrate into the package through the hole penetrated in the side of pouch when attaching fitments.

Therefore, it would be very advantageous to provide a pressure relief valve for use in flexible pouches used in the food industry which is incorporated directly into the structure and material of the pouch and avoids the need for external fitments to be attached to the pouch. For example, as mentioned above, fresh ground coffee produces copious carbon dioxide as a by-product of the roasting process. Therefore it would be very useful to provide a controlled release mechanism built directly into the packaging in which the fresh ground coffee is sealed in order to allow the carbon dioxide gas to disperse to the atmosphere after roasting while at the same time preventing oxygen from the atmosphere entering the pack and causing the coffee grounds to go stale.

### SUMMARY OF THE INVENTION

The present invention provides a pressure relief valve for a flexible pouch which is integrated directly into the flexible pouch material. The valve permits excess pressure due to gas generated in the pouch to dissipate through the valve mechanism but does not permit the reentry of air/oxygen back into the pouch. The valve is integrated into the pouch material without implanting a fitment. The nature of the valve design results in the closing of the channels of the valve when gas is not discharging through the valve. When the internal pressure equalizes with the external pressure the channel closes at one or more points along its length thus preventing oxygen from back-flowing and entering the pouch.

A secondary purpose of the valve is to maintain the pressure in the pouch below an amount that can bloat the pouch to the extent that the seals can rupture and permit oxygen penetration or spilling of the contents outside the pouch.

The present invention provides a flexible pouch, comprising:

a) opposed sheets of flexible polymeric film material sealed together around a peripheral edge of each sheet enclosing a storage chamber therebetween for a foodstuff to be stored therein, the flexible polymeric film material having a pre-selected film suppleness; and

b) at least one pressure relief valve formed directly in the flexible polymeric film material, the at least pressure relief valve including at least one valve entrance, and at least one channel passageway terminating in a valve outlet which define a passageway from the storage chamber to the exterior of the pouch, the at least one channel passageway having an effective tortuosity which, in combination with the pre-selected film suppleness, results in opening of the at least one pressure relief valve when a threshold pressure is surpassed in the storage chamber to permit an over abundance of gas generated by the food stuff to be vented through the pressure relief valve and when the pressure drops below the threshold pressure the channel passageway closes at one or more points along its length thus substantially inhibiting back-flow of air back into the storage chamber.

In another aspect of the invention there is provided a flexible pouch for containing food products comprising flexible sheets sealed together around a peripheral edge of the flexible sheets and defining therebetween a storage compartment for containing therein a food product. A pressure relief valve is integrally formed in a peripheral edge portion of the flexible sheets. The pressure relief valve has an effective torturous channel and geometry so that it remains closed when an internal pressure inside the storage compartment is below a pre-selected pressure but opens when the pre-selected pressure is exceeded and when the pressure drops below the threshold pressure the channel passageway closes at one or more points along its length thus substantially inhibiting back-flow of air back into the storage chamber.

### BRIEF DESCRIPTION OF THE DRAWINGS

Preferred embodiments of the invention will now be described, by way of example only, with reference to the drawings, in which:

FIG. 1a shows a valve produced as a mirror image and machined into the face of heat seal dies;

FIG. 1b shows a view of a flexible pouch into which the valve of FIG. 1a is incorporated;

FIG. 2a shows another embodiment of a valve created as a mirror image and machined into the face of heat seal dies;

FIG. 2b shows a view of a flexible pouch into which the valve of FIG. 2a is incorporated;

FIG. 3a shows another embodiment of a valve created as a mirror image and machined into the face of heat seal dies;

FIG. 3b shows a view of a flexible pouch into which the valve of FIG. 3a is incorporated;

FIG. 4a shows another embodiment of a valve created as a mirror image and machined into the face of heat seal dies;

FIG. 4b shows a view of a flexible pouch into which the valve of FIG. 4a is incorporated;

FIG. 5 shows a pouch constructed of flexible polymer sheets incorporating a valve constructed in accordance with the present invention;

FIG. 6 shows a partial pouch, broken away, incorporating a valve having a different outlet design to the valve used in FIG. 5;

FIG. 7 shows a gable style pouch showing the placement of the center seal, folded tucks and various side seal areas that are designed for amount of product to be packaged and marketing determinations as to the style and method of presentation;

FIG. 8 is another embodiment of a gable-style pouch with a valve designed to fit into a smaller portion of the pouch compared to the design of FIG. 7;

FIG. 9 shows a top view showing the gable top format which shows two separate layers of polymer film tucked before sealing;

FIG. 10 shows the top section of the pouch of FIG. 7; and

FIG. 11 shows the two separate layers of film in the tuck area folded and sealed in the gable top pouches of FIGS. 7 or 8.

### DETAILED DESCRIPTION OF THE INVENTION

The present valve for flexible pouches is used for stabilization of nitrogen cap after forming, filling and sealing product during in-line production and offers guarded protection of the contents. The nitrogen cap is used to displace oxygen during filling and also designed to keep oxygen (O₂) from entering into the pouch when stored and thus maintains freshness of the products. The valve disclosed herein constitutes a specially designed valve that is multifunctional. The valve prevents the pouch from excessive expansion or bloating, which can fracture or split the film material and/or weaken or open the seals. The valve also prevents oxygen from re-entering the pouch by self-sealing thus maintaining freshness.

Not wishing to be bound by any theorem or formula, the gas release valve system formula on which the present invention is based may be approximated by the representation: A+B+C=D where A represents the composition of the film structure and the number of laminations which cause suppleness or stiffness. Film structures are now produced in virtually hundreds of combinations of layers, substructures, slip factors, sealants, including variations in linearity. Each of these elements creates different characteristics; B represents the pressure of the gas generated by the product in the package, is measured in millibars or PSI, pounds per square inch, depending upon the method of measurement used by the various quality assurance departments, C represents the pre-formed gas release valve design which must consider the size, shape, compression factors of gas, outside atmospheric pressure and serpentine design patterns of the entrance, chambers and exits. The combination of A, B, and C gives D which is the outflow rate of gases.

The formula for this special design is predicated on the film structure, the pressure created by gases generated from the product contents and the physical design of the valve chamber. All elements of the formula must be predetermined before designing. Bipolar alignment is critical to directional vector analysis in applying pressure while containment in the trap chamber stabilizes the amount of pressure exerted on the exit channel. When pressure builds, that pressure seeks all avenues wherein the gases are contained. When the chambers are filled, the pressure at one end of the bipolar points seeks the other polar coordinates and the pressures created can literally distort the film creating folds, creases or pockets. This is corrected by adjusting the design to compensate or move the stress points. The force is then re-directed by design to compete with linearity, shape and direction. The valve only opens when excess gases generate a given threshold pressure. In the case of coffee, increase of gas builds up right after roasting and continues during various amounts of time until gas generation is reduced. This release of gases reduces swelling of pouches and avoids bursting of seals. This action maintains freshness while expelling only some of the gas and restricts the intake of oxygen back into the pouch.

The invention will now be illustrated with reference to the following non-limiting but exemplary pouches.

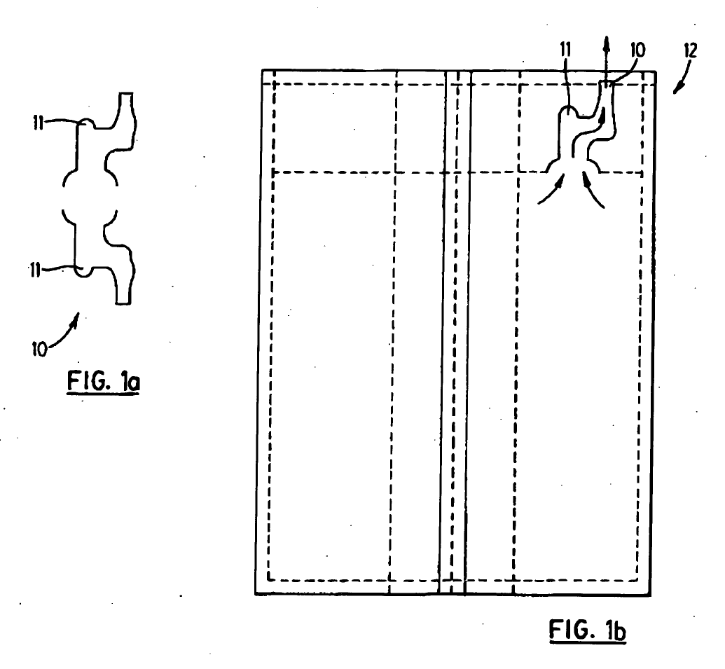

FIGS. 1a and 1b show respectively a drawing of a valve 10 and its placement in a pouch 12 constructed in accordance with the present invention. Valve 10 is created as a mirror image of the valve imprinted into the pouch material and is machined into the face of a heat seal die used to seal the pouch once it is filled with the food product. Depending upon the packaging machine in which the dies are normally used the position or orientation of the mirror image will be located according to the requisites of the physical pouch to be formed, filled and sealed.

The film structure, number of layers, stiffness or suppleness, moisture and gas transmission rates which vary significantly depending upon the vendor formula, orientation of polymers, sealants and lubricity of the surfaces, contribute to the forces that impact the design and the ultimate expulsion of gases and the blocking of oxygen re-entry.

In valve 10, the extension region 11 assists in controlling the tortuous channel formation. The bipolar points seek the other polar coordinates and pressures created by design to compensate or move the stress points. The force is then re-directed to compete with linearity, shape and direction when gas is being expelled from pouch 12 out through valve 10 in the direction of the arrows.

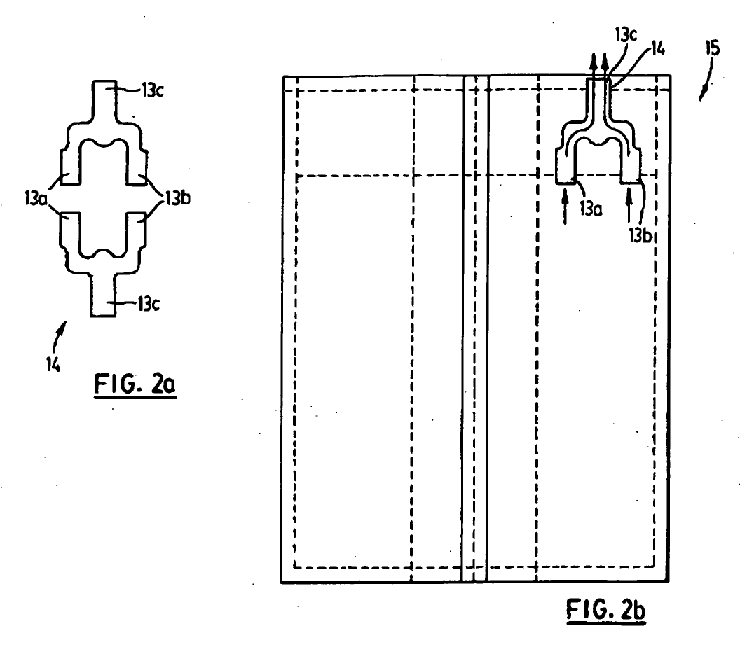

FIGS. 2a and 2b show respectively a drawing of another embodiment of a valve 14 and its placement in a pouch 15. Two entrances 13a and 13b on the inside of the pouch 15 are separated along an identical plane accept gases created by product contents and exits through the single exit 13c as shown in FIG. 2b. This double entrance valve 14 permits greater force when the gas accumulates in the center of the valve. As already stated the film structure impacts the movement of gases.

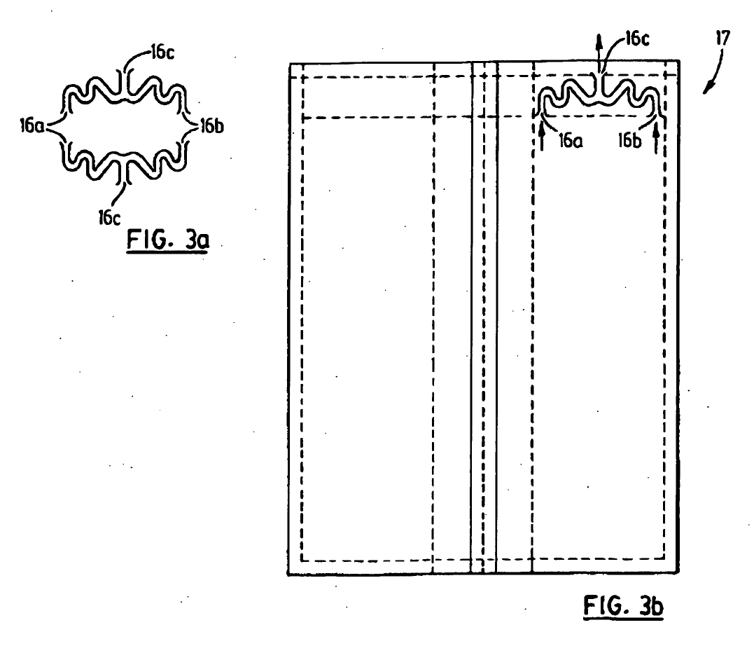

FIGS. 3a and 3b show embodiment of a valve 16 and its placement in a pouch 17 with valve 16 having two entrances 16a and 16b and one exit 16c. The design form is radically different as valve 16 has extremely torturous outlet paths and much tighter or narrower channel positions. This valve design creates greater control of gas emissions and oxygen ingestion.

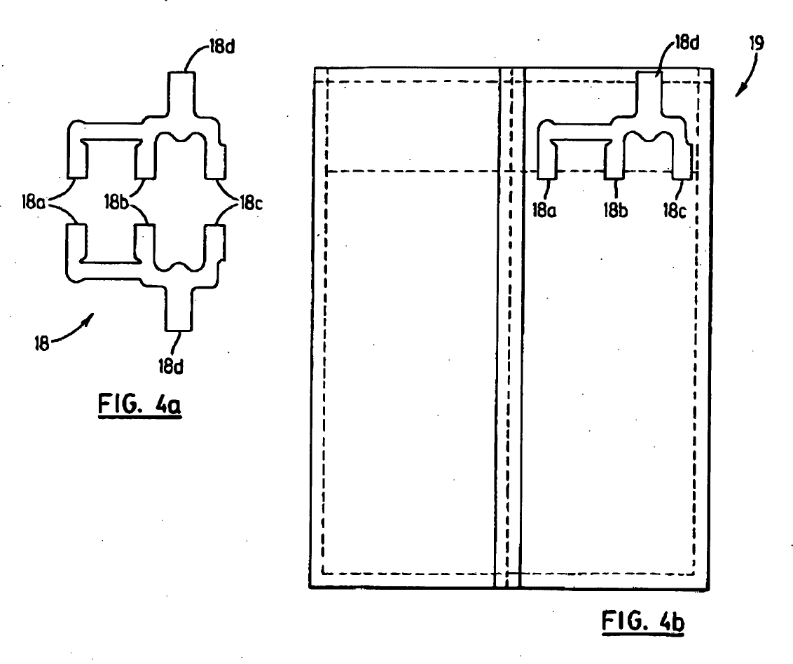

FIGS. 4a and 4b show respectively a drawing of another embodiment of a valve 18 and its placement in a pouch 19 with valve 18 including three entrances 18a, 18b and 18c on the inside of the pouch 19 which are separated along an identical plane and accept gases created by the product contents. Additional entrances can overcome a clogging problem in the event one or more entrances become physically blocked by the product. The product consistency is a factor. All entrances 18a, 18b and 18c are extended by passageways which merge to exit the pouch exterior through a single exit passageway 18d as shown.

FIG. 5 shows a pouch 20 constructed in accordance with the present invention. Pouch 20 includes a product holding area 22 that is located between two opposed flexible sheets 24. Sheets 24 are sealed around the peripheral edge 26 of the pouch 20 indicated by the broken lines 28 with the top portion of the pouch being sealed along two spaced lines 28 between which a pressure relief valve 30 is formed and located. The freshness of the product contained within the product holding area 22 is determined by the pressure sensitive valve 30, which is formed integrally with the pouch 20 on opposing surface areas of each lateral edge portion between broken lines 28 of the front wall panel and back wall and is comprised of tortuous pathway sections 32, 34, 36, 38, 39 and outlet 40.

The sensitivity of the valve action of valve 30 is increased or decreased according to the suppleness or stiffness created by the multiple film structures and correspondingly relates to the position of chamber extensions 36 and 39. When the gas enters the chambers 32 and 34, the gas operates as a pneumatic force and when the pneumatic pressure created by the gas fills extension 36, the pressure against the film extends the channel orientation of the filled cavity to increase the force elongating that area and impacts the film orientation. This action can prevent the film from folding or locking closed on a longitudinal tangent. Extension 39 works as a latitudinal force keeping the pathway straight and open.

The valve 30 is inserted during the in-line production of forming, filling and sealing process for the food product and may be inserted at either the top or bottom of the pouch 20. The valve 30, made up of a channel entrance 32, passageway sections 34, 36 and 38, is sealed into the pouch 20 by a specially designed heat seal die that is designed for volume displacement and dictates the flow rate of escaping gas. The longitudinal shape extension of section 36 maintains a clear passageway. It reduces excess gas pressure and when the internal pressure equalizes with the external pressure the channel closes at one or more points along its length thus preventing air, hence oxygen, from entering the pack. During release of the excess pressure, this higher pressure restricts the entry of air back as the pressure in the space and volume within the valve is greater than the external ambient air pressure. Longitudinal force acts as a shaping mechanism and varies according to pressure, B, and film structure, A. This original technique is designed to control the radical nature of free forming polymer structures. All elements of the formula are predetermined before designing. Bipolar alignment is critical to directional vector analysis in applying pressure while containment in the trap chamber stabilizes the amount of pressure exerted on the exit channels. If the alignment factors change along any given arc, or pathway, the valve action will be altered and will increase or decrease the flow of exiting gas. The mechanism has taken many forms due to the geometric combinations found in the formula. Several hundred designs have been developed due to the radical variations in film structures; a variety of gas pressures created from product contents; and form, fill, heat and seal pressures created by different types of machines.

The present pouch with the pressure relief valve has geometric combinations that affect the freshness and containment of processed food packed in the flexible pouches. Those skilled and experienced in the various technologies of food processing must weigh the impact of each element since different polymer materials behave differently to external forces. Reaction to pressure, heat and forming constitutes only one element of the invention. Suppleness, stiffness, sealants, slip factors and linearity of the film are adjusted in response to the requirements of the product sealed in the pouch. The design technology is a function of the combination of radial symmetry, distortion created under forming and pressure, and pre-forming channels. In the case of coffee, the present valve maintains the required gas pressure to preserve the nitrogen cap while maintaining minimum oxygen levels.

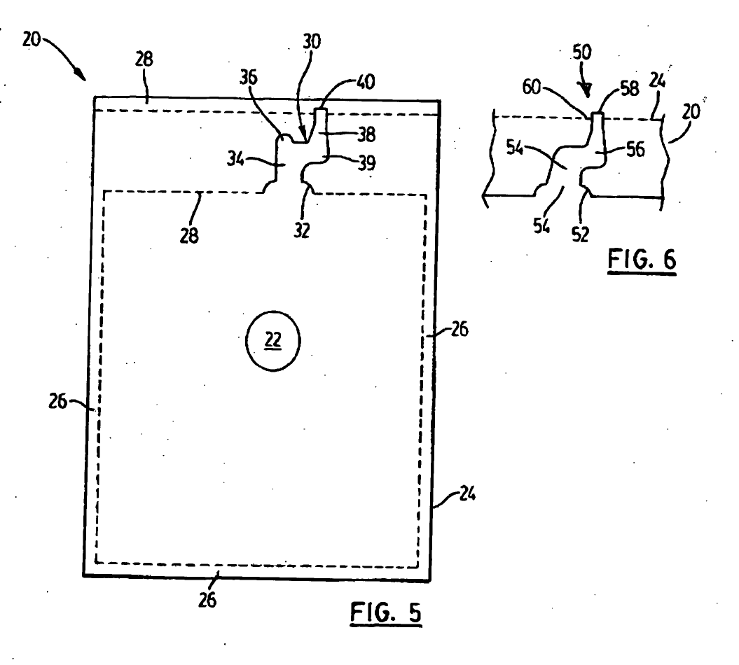

Referring to FIG. 6, another embodiment of a valve 50 is similar to valve 30 in FIG. 5 but in which passageway 54 of valve 50 has been modified from passageway 34 of valve 30 to eliminate the extension section 36 (FIG. 5) which forces the gases to follow a more severe angular turn, causing the flexible sheets 24′ of pouch 20′ (FIG. 6) to be stretched in a different direction than in the pouch sheets 24 of pouch 20 (FIG. 5). This action impacts on the stretching of the film depending upon the orientation of the film structure, such as biaxially oriented film. The film variations increase or decrease the resistance to expansion. The mil spec of the film relating to thickness also impacts the stretching process.

The valve 50 shown in FIG. 6 also has a wider entry with entrance 52 being wider than entrance 32 in valve 30 (FIG. 5) thus permitting more gas to fill the lower passageways 54 and 56 of valve 50 which exerts an increased amount of pressure in the valve entrance 52. As the pressure builds in the passageway channel area 54 it compels the pressure to increase in force in the narrower passageway channel 56 leading to outlet 58. The pressure can be controlled by the size of the channel section 56 and exit 58. The more supple the film and higher slip factor the tighter and/or reduced width of the entrance chamber 52, (inside the pouch), central chamber passageway 54 and less torturous pathways from the central chamber through the exit channel 56 and 58 can increase the flow rate.

The valve 50 remains in a latent state of openness, as the tip of the exit 58 is not sealed due to the configuration of the heat seal die. This portion of the die does not seal to the end of the pouch due to the physical knife blade occupying space 60 in the production process. The function of gas release is secondary to maintaining freshness. The valves 30 and 50 preferably maintain a closed position when the pressure in millibars is in the range from about 0.04 to about 0.06. This prohibits air from re-entering the exit 58 or passageway section 56. This restriction of entry of oxygen maintains the freshness of the product contained in product area 22.

The millibar pressure may be determined in a vacuum water filled chamber. This pressure must be analyzed along with the linearity of the film and the stress impact on the channel and chamber designs. Observation by the technician looking through the glass tank displays the contortions of the flexible pouch channel-way, the valve, when the vacuum is increased or decreased. It will be very apparent to the trained technician who then determines if the design combined with the film structure releases gas at the desired pre-determined pressure.

When the film structures change, and/or gas increases or decreases due to different product contents which may produce more or less gas, the design of the valves must be altered to accommodate the resistance factor of the film and amount of pressure.

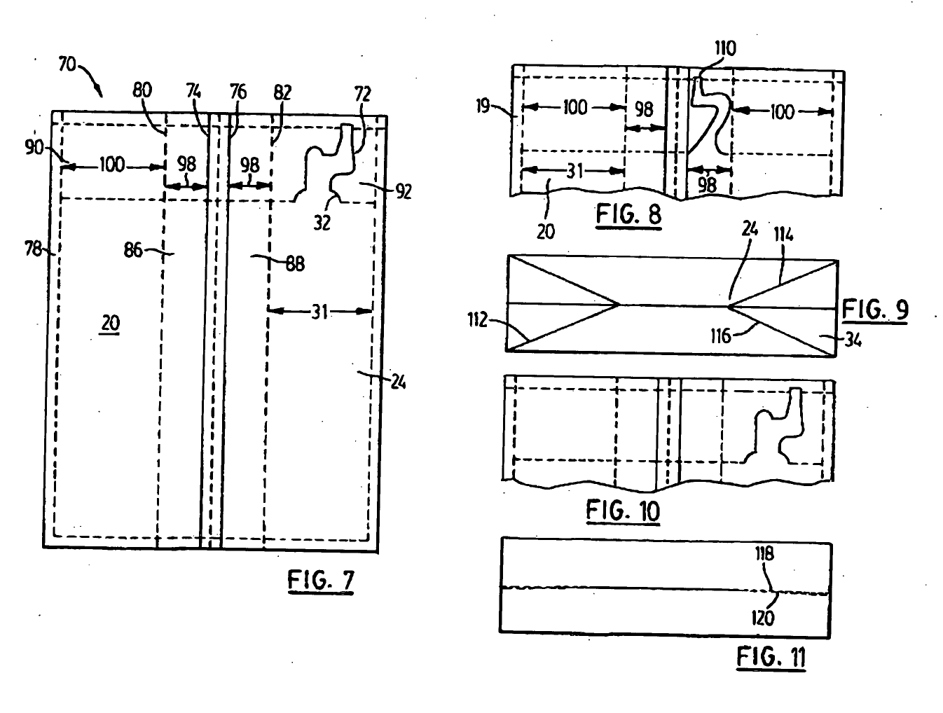

FIG. 7 shows a gable style pouch 70 showing the placement of the center seal, folded tucks and various side seal areas that are designed for the amount of product to be packaged and marketing determinations as to the style and method of presentation. The placement of the valve 72 becomes a fabrication decision depending upon space allocations developed. The space allocation avoids centerfolds, tuck folds and all seal areas in the pouch. The valve must fit within these spaces after positioning is determined.

More particularly, FIGS. 7 to 11 illustrate a different style pouch 70 known as a 4-sided pouch with a gable top. The four edges or corners are sealed to make the pouch more stable when standing up as shown in FIGS. 9 and 11. The placement of the valve 72 in the top of flexible film pouch 70 must be in a position so as not to overlap the center seal 74, 76, the side seals 78, or the folds in gable top formations 80 and 82 (FIG. 7). The spaces beginning with 86, 88, 90 and 92, are selected carefully as they influence the size relationship and placement of the valve 72, space allocation must be determined, that is, the area needed to accommodate the valve design and shape. Folds, tucks, back seals all require positioning of the valve so as not to distort the design.

In FIGS. 7 and 8 the widths indicated by numerals 98 and 100 may be a matter of 13 millimeters wide up to 65 millimeters wide. Pouch width size determines the “Space Allocation”. The valve 110 shown FIG. 8 when confined to space 98 will out of necessity be restructured in design size to fit the area. The space 100 allows for a more expansive valve application when applicable. Referring to FIGS. 9 and 11, a top view is shown in FIG. 9 before heat sealing, and in FIG. 11 after heat sealing. FIG. 7 is a side view showing placement of 28 in both FIG. 9 and FIG. 10. The valve 110 must not be heat sealed over a fold in polymer sheets 24 in the case of a gable top pouch format.

Referring to FIG. 9, one of the unique features of the space allocation is that the valve 110 can be placed within the folded gable top section 112 which becomes four layers of film instead of two layers. This actually creates two independent valves 114 and 116 that are face to face with each other. The film structures are duplicated in the fold of the gable top making four layers. The heat seal of the valves 114 and 116 do not interfere with each other. The valves 114 and 116 actually are two separate entities, which are created and heat sealed only where the film sealant facing polymers touch each other 118 and 120. Film structures used with food products vary from two to six layers so the mil specs increase with each layer. This effects the stiffness or suppleness of the film so the stretch factors in the valve area becomes more resistant to the multilayer film structures. This stretching is a function of the gas pressure build up and generated by the product contents and occurs over a period of time. The pressure and film structure effects the size and shape of the valve design. The geometric combination necessities a complete list of film structures and gas pressures as well as cubic millimeters of the pouch when filled.

Packaging films are divided into face substrates and sealants. Stiff, biaxially oriented film is used as the face substrate and non-oriented film as sealant. With respect to polypropylene, biaxially oriented polypropylene enhances stiffness and cold resistance, but lowers sealability compared to non-oriented CPP. Many film laminates and/or structures are produced which combine face substrates and sealants, noting that CPP may be used as a single layer film for over-wraps, textile and vegetable packaging, partially coated pouches while CPP is generally used for bread and textile packaging.

In the present invention there is a direct correlation between the film structure and the valve design when determining the selection of film types needed to achieve a given gas release factor as equated to a given valve design. The interdependence of the two elements is interlocked by virtue of their specific reactions to pressure and containment. In the case of the film structure we can show where each film has a discrete reaction to pressure. A sealed film container that is stiff in composition will appear to bulge or swell only slightly when pressure is exerted by internal gas. A medium density film with less mils of material will show a greater swelling affect than a stiffer lamination. A supple film structure, which would be considered to be the thinnest material with a minimum mil spec, would show an excessive ballooning affect.

Examples of these film structure laminations are:

Stiff or heavy lamination: 3 or 4 ply, COEX. OPP/ALU 9/PE (30-100) var ga.

Medium flexibility lamination: 3 ply, COEX. OOP/MET. PEPT 12/PE var ga.

Supple or very thin lamination: 2 ply, MET. PETP 12/PE (30) (40) (50) GA.

In the case of the heavy stiff lamination a wider channel or series of channels, as exemplified by pouches 15 and 19 in FIGS. 2a and 4a, becomes necessary in order to open the valve sufficiently to let gas evacuate.

The pouches 12 and 15 shown in FIGS. 1b and 2b respectively would be more suitable for a medium lamination. The pouch 17 shown in FIG. 3b would be more reliant upon a supple lamination. When the film and general valve design are determined, then fine tuning of the valve, that is, changes in the design may be made and tested to meet the desired pressure release threshold standards established in a water filled vacuum tank. The critical shape of the valve must meet the pre-selected threshold release pressure of the gas but must also restrict the entrance of oxygen back through the valve when the pressure is lowered below the threshold pressure. The seals must be strong enough not to break. The combinations of film structures that may be produced in accordance with the present invention are numerous thus it will be understood that there are a large number of variations in valve design possible. Both of these factors are again impacted by the amount of gas generated and its inherent pressure.

The flexible pouch with the pressure relief valve disclosed herein is advantageous over existing systems for the following reasons: the food product can be packed immediately after processing even though it may still be producing gases as a result of the processing steps (for example roasting coffee grounds) thus maximizing freshness of the product. In addition to excluding back-flowing air (hence oxygen), it allows the use of a controlled atmosphere (typically N2 used to form a nitrogen cap). In addition, there are no moving parts to fail or to become dislodged and become embedded in the product. There is no glue or silicone present such as the case with other products which use fitments.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims.

Therefore what is claimed is:

1. A flexible pouch, comprising:
a) opposed sheets of flexible polymeric film material sealed together around a peripheral edge of each enclosing a storage chamber there between for a foodstuff to be stored therein, the flexible polymeric film material having a pre-selected film suppleness; and
b) at least one pressure relief valve formed directly in the flexible polymeric film material, the at least pressure relief valve including at least one valve entrance, and at least one channel passageway terminating in a valve outlet which define a passageway from the storage chamber to the exterior of the pouch, the at least one channel passageway having an effective tortuosity which, in combination with the pre-selected film suppleness, results in opening of the at least one pressure relief valve when a threshold pressure is surpassed in the storage chamber to permit an excess of gas generated by the food stuff to be vented through the pressure relief valve and when the pressure drops below the threshold pressure the channel passageway closes at one or more points along its length thus substantially inhibiting back-flow of air back into the storage chamber.

2. The flexible pouch according to claim 1 wherein the effective tortuosity and the pre-selected film suppleness are chosen to maintain an internal pressure in the chamber below an amount that can bloat the pouch to the extent that the seals can rupture and permit oxygen penetration or spilling of the contents outside the pouch.

3. The flexible pouch according to claim 1 wherein said at least one valve entrance is one valve entrance and wherein said at least one channel passageway is one channel passageway having at least one 90 degree, or greater, turn between the one valve entrance and the valve outlet.

4. The flexible pouch according to claim 3 wherein the at least one channel passageway is one channel passageway, and wherein the at least one valve entrance is one valve entrance which narrows down to the one channel passageway.

5. The flexible pouch according to claim 1 wherein the at least one valve entrance is two valve entrances spaced apart from each other, and wherein the at least one channel passageways is two channel passageways each being in flow communication with one of the two valve entrances, the two channel passageways merging into a common outlet passageway which terminates at the valve outlet and each of the two channel passageways having at least one 90 degree, or greater, turn between its associated valve entrance and the common outlet passageway.

6. The flexible pouch according to claim 1 wherein the at least one valve entrance is two valve entrances spaced apart from each other, and wherein the at least one channel passageways is two channel passageways each being in flow communication with one of the two valve entrances, the two channel passageways merging into a common outlet passageway which terminates at the valve outlet and each of the two channel passageways having a plurality of 90 degree, or greater, turns between its associated valve entrance and the common outlet passageway.

7. The flexible pouch according to claim 1 wherein the pouch encloses fresh roasted ground or whole bean coffee.

8. A flexible pouch for containing food products, comprising:
a) flexible sheets sealed together around a peripheral edge of the flexible sheets and defining therebetween a storage compartment for containing therein a food product; and
b) a pressure relief valve integrally formed in a peripheral edge portion of the flexible sheets, the pressure relief valve having an effective torturous channel and geometry so that it remains closed when an internal pressure inside the storage compartment is below a pre-selected pressure but opens when the pre-selected pressure is exceeded and when the pressure drops below the threshold pressure the channel passageway closes at one or more points along its length thus substantially inhibiting back-flow of air back into the storage chamber.

9. The flexible pouch according to claim 8 wherein the pressure relief valve is a one-way valve including at least one valve entrance, and at least one channel passageway terminating in a valve outlet which defines a passageway from the storage compartment to the exterior of the pouch.

10. The flexible pouch according to claim 9 wherein the flexible sheets include flexible polymeric film material.

11. The flexible pouch according to claim 10 wherein the at least one valve entrance is two valve entrances spaced apart from each other, and wherein the at least one channel passageways is two channel passageways each being in flow communication with one of the two valve entrances, the two channel passageways merging into a common outlet passageway which terminates at the valve outlet and each of the two channel passageways having a plurality of 90 degree, or greater, turns between its associated valve entrance and the common outlet passageway.

12. The flexible pouch according to claim 9 wherein the pouch encloses fresh roasted ground or whole bean coffee.
